(19) United States
(12) Patent Application Publication
(10) Pub. No.: US 2015/0249945 A1
(43) Pub. Date: Sep. 3, 2015

(54) ENHANCED FAILED CELL ACQUISITION OPERATION

(71) Applicant: QUALCOMM Incorporated, San Diego, CA (US)

(72) Inventors: Srujith Reddy Katamreddy, Hyderabad (IN); Mungal Singh Dhanda, Slough (GB); Farrukh Rashid, Farnborough (GB); Zhong Fan, Guildford (GB); Ian Thomas Patten, Southampton (GB)

(73) Assignee: QUALCOMM Incorporated, San Diego, CA (US)

(21) Appl. No.: 14/193,813

(22) Filed: Feb. 28, 2014

(51) Int. Cl. H04W 36/14; H04W 76/02

(52) U.S. Cl. CPC H04W 36/14; H04W 76/025

(57) ABSTRACT

Embodiments of the present invention include devices, systems and methods for enhanced failed cell acquisition operation. For example, a method for wireless communication is described. The method includes performing subsequent combined acquisition of a neighbor cell based on a stationary mode and a mobility mode. Other aspects, embodiments, and features are also claimed and described.

### TECHNICAL FIELD

The technology discussed below relates generally to communication systems, and more specifically, to systems and methods for enhanced failed cell acquisition operation. Implementation of aspects of the technology discussed below can provide efferent use of power resources and provide positive user experience via network acquisitions.

### BACKGROUND

Wireless communication systems have become an important means by which many people worldwide have come to communicate. A wireless communication system may provide communication for a number of wireless communication devices, each of which may be serviced by a base station.

Users of wireless communication devices desire that their devices have many features. For example, a user may expect to power on a wireless communication device and immediately make or receive a phone call or use the device for other purposes. Generally, however, wireless communication devices must perform initial acquisition and decoding procedures before service can be obtained and wireless communications can be established. These procedures may need to be performed when a wireless communication device is operating in an idle state. And in some instances, these procedures may fail when the wireless communication device is in stationary conditions.

### BRIEF SUMMARY OF SOME EXAMPLES

Embodiments of the present invention address the above issues as well as others. Indeed, embodiments of the present invention provide power efficient devices, systems, and methods that can alleviate time delays. Doing so can not only utilize power resources efficiently but can aid in minimizing delays associated with network communications.

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A method for wireless communication is described. The method includes performing subsequent combined acquisition of a neighbor cell based on a stationary mode and a mobility mode.

The combined acquisition of the neighbor cell comprises at least one of a frequency correction channel (FCCH) acquisition and a synchronization channel (SCH) decoding of the neighbor cell. The method may also include suspending subsequent combined acquisition of the neighbor cell after one combined acquisition failure or a plurality of combined acquisition failures while in stationary mode.

The method may also include switching to mobility mode. The method may further include removing a suspension of the combined acquisition of the neighbor cell.

The method may also include switching from stationary mode to mobility mode based on changes to a mode trigger flag. The mode trigger flag may be based on variation of at least one of a serving cell receive power, a serving cell signal to noise ratio, a receive power of one or more neighbor cells, a signal to noise ratio of one or more neighbor cells, and a change in a neighbor cell list.

The method may also include switching from mobility mode to stationary mode when the mode trigger flag indicates a stationary condition after a first time period. The method may further include switching from stationary mode to mobility mode when the mode trigger flag indicates a mobility condition after a second time period.

The method may also include receiving a neighbor cell list on a broadcast channel. The method may further include initiating a FCCH acquisition of a neighbor cell while in mobility mode. The method may additionally include switching from the mobility mode to the stationary mode after a failure of the FCCH acquisition of the neighbor cell based on changes to a mode trigger flag. The method may also include initiating a combined acquisition of a neighbor cell while in stationary mode.

An apparatus for wireless communication is also described. The apparatus includes a processor, memory in electronic communication with the processor and instructions stored in the memory. The apparatus performs subsequent combined acquisition of a neighbor cell based on a stationary mode and a mobility mode.

A wireless device is also described. The wireless device includes means for performing subsequent combined acquisition of a neighbor cell based on a stationary mode and a mobility mode.

A computer-program product for wireless communications is also described. The computer-program product includes a non-transitory computer-readable medium having instructions thereon. The instructions include code for causing a wireless communication device to perform subsequent combined acquisition of a neighbor cell based on a stationary mode and a mobility mode.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 shows a wireless communication system with multiple wireless devices according to some embodiments;

FIG. 2 is a flow diagram of a method for enhanced failed cell acquisition operation according to some embodiments;

FIG. 3 is a block diagram illustrating a radio network operating according to embodiments of the present invention;

FIG. 4 illustrates an absolute radio frequency channel (ARFCN) multiframe according to some embodiments;

FIG. 5 is a state diagram illustrating transition between a mobility mode and a stationary mode;

FIG. 6 is a block diagram illustrating a more detailed embodiment of a wireless communication system with wireless devices configured for enhanced failed cell acquisition operation;

FIG. 7 is a flow diagram of a method for another embodiment of enhanced failed cell acquisition operation; and

FIG. 8 illustrates certain components that may be included within a wireless communication device according to some embodiments.

### DETAILED DESCRIPTION

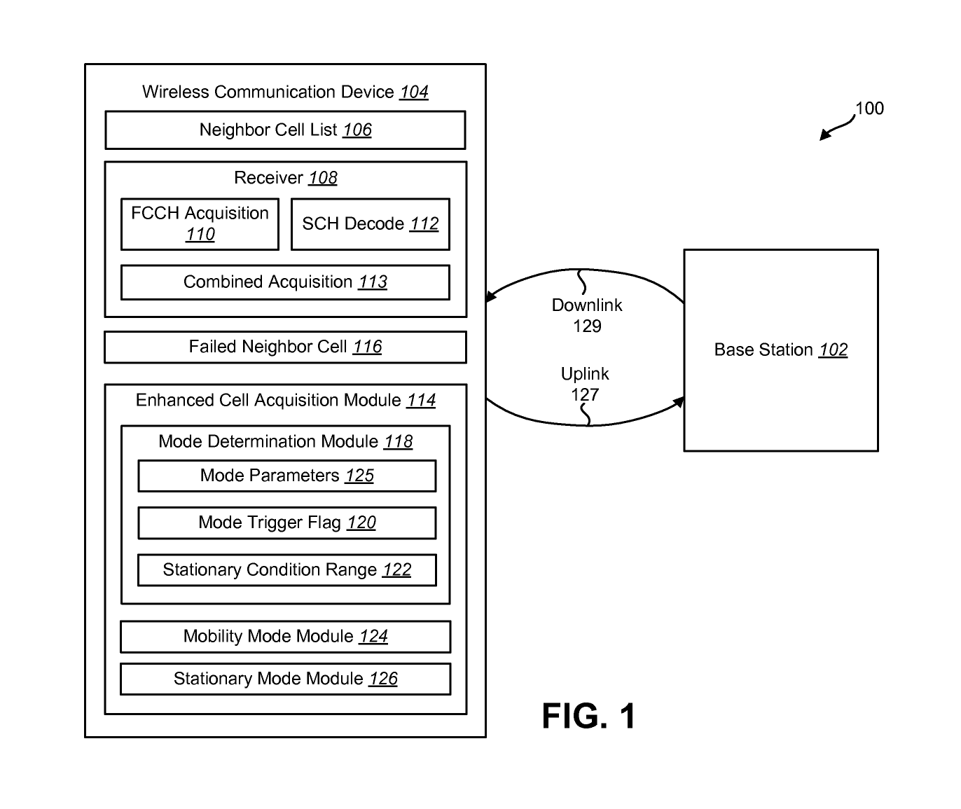

FIG. 1 shows a wireless communication system 100 with multiple wireless devices according to some embodiments. Wireless communication systems 100 are widely deployed to provide various types of communication content such as voice, data and so on. A wireless device may be a base station 102 or a wireless communication device 104. The wireless communication device 104 may be configured for enhanced failed cell acquisition operation. For example, the wireless communication device 104 may be configured to perform power-efficient failed neighbor cell frequency correction channel (FCCH) acquisition under stationary conditions.

A base station 102 is a station that communicates with one or more wireless communication devices 104. A base station 102 may also be referred to as, and may include some or all of the functionality of, an access point, base transceiver station (BTS), a broadcast transmitter, a NodeB, an evolved NodeB, etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless communication system 100 (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (WCDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes WCDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one or multiple base stations 102 on the downlink 129 and/or uplink 127 at any given moment. The downlink 129 (or forward link) refers to the communication link from a base station 102 to a wireless communication device 104, and the uplink 127 (or reverse link) refers to the communication link from a wireless communication device 104 to a base station 102. A wireless communication device 104 may be configured to use Global System for Mobile Communications (GSM), Long Term Evolution (LTE), wireless fidelity (Wi-Fi) and wideband CDMA.

Each channel in GSM is identified by a specific absolute radio frequency channel (ARFCN). Also, each base station 102 is assigned one or more carrier frequencies. Each carrier frequency is divided into eight time slots (which are labeled as time slots 0 through 7) using TDMA such that eight consecutive time slots form one TDMA frame with a duration of 4.615 milliseconds (ms). A physical channel occupies one time slot within a TDMA frame. Each active wireless communication device 104 or user is assigned one or more time slot indices for the duration of a call. User-specific data for each wireless communication device 104 is sent in the time slot(s) assigned to that wireless communication device 104 and in TDMA frames used for the traffic channels.

In GSM, a wireless communication device 104 operating in idle mode may receive a neighbor cell list 106. In one configuration, the neighbor cell list 106 may be an idle mode broadcast control channel (BCCH) allocation (BA) list. The neighbor cell list 106 may be received via a BCCH system information (SI) type 2 message. The network may broadcast up to 32 surrounding neighbor cells in the neighbor cell list 106.

Upon receiving the neighbor cell list 106, the wireless communication device 104 may perform a frequency correction channel (FCCH) acquisition 110 and synchronization channel (SCH) decode 112 on each broadcasted neighbor cell to obtain a base station identification code (BSIC) and frame number (FN) of the neighbor cell. The FN directs the wireless communication device 104 to read the BCCH of the neighbor cell, which includes SI messages.

The wireless communication device 104 may initiate an FCCH acquisition 110 of a neighbor cell included in the neighbor cell list 106. In one configuration, the wireless communication device 104 may perform FCCH acquisition 110 and SCH decoding 112 using at least one of an antenna, a processor and memory. The wireless communication device 104 may perform a scan of the ARFCN of the neighbor cell using a receiver 108.

The wireless communication device 104 may scan the ARFCN to find an FCCH. The FCCH is a downlink-only control channel in the GSM Um air interface that enables the wireless communication device 104 to lock a local oscillator (LO) to the base station 102 clock. The FCCH may be transmitted in frames immediately before the synchronization channel (SCH). Thus, once a wireless communication device 104 has found the FCCH, the wireless communication device 104 can then find and decode the SCH.

If the ARFCN is a BCCH, the ARFCN may include a 67 kHz tone (which is the FCCH) that is repeated approximately every 50 ms. Once the FCCH is found (e.g., acquired), the next frame (4.6 ms later) will be the synchronization channel (SCH). The SCH may include information corresponding to a public land mobile network (PLMN) search and registration necessary for the wireless communication device 104 to start a call or camp on a serving cell. The wireless communication device 104 may then decode the SCH. The wireless communication device 104 may decode the synchronization channel (SCH) using at least one of an antenna, a processor and memory.

The wireless communication device 104 may perform frequency and time synchronization based on a FCCH acquisition 110 and an SCH decode 112. The wireless communication device 104 may perform frequency synchronization with the neighbor cell based on the FCCH acquisition 110. The wireless communication device 104 may perform time synchronization with the neighbor cell based on the SCH decode 112. In one configuration, the FCCH acquisition 110 (e.g., the frequency synchronization) may take place before the SCH decode 112 (e.g., time synchronization).

On some occasions, the wireless communication device 104 may not successfully perform FCCH acquisition 110 or SCH decode 112 for one or more broadcasted neighbor cells. These failures may be due to the surrounding radio frequency (RF) conditions. For example, the neighbor cell may have a low signal to noise ratio (SNR) or the neighbor cell may experience interference with other neighbor cells. As used herein, a failed neighbor cell 116 is a neighbor cell for which the wireless communication device 104 fails to acquire the FCCH or decode the SCH.

In one case, the wireless communication device 104 may fail to acquire the FCCH of the neighbor cell. In this case, the wireless communication device 104 may not decode the SCH of the neighbor cell. In another case, the wireless communication device 104 may correctly acquire the FCCH, but may fail to decode the SCH. In yet another case, the wireless communication device 104 may incorrectly assume that it acquired the FCCH (due to noise interference, for example), and the subsequent SCH decode 112 may fail due to one or more failed cyclic redundancy checks (CRC).

Each failed FCCH acquisition 110 may consume x milliamps (mA) of current for a failure event that lasts y milliseconds (ms). Furthermore, failed FCCH acquisition 110 may account for a total of z mA of standby current. It has been observed that each failed FCCH acquisition 110 may consume approximately 75 mA for a failure event that lasts approximately 60 ms. In terms of total standby current, these failures may account for approximately 1.5-2 mA in a single subscriber identity module (SIM) device under stationary conditions. The power consumption may be much higher for a wireless communication device 104 that has multiple SIMs (e.g., dual SIM dual standby (DSDS), dual SIM dual active (DSDA), triple SIM triple standby (TSTS), etc.).

In a known approach, the wireless communication device 104 may perform an FCCH acquisition 110 or an SCH decode 112 based on a failed neighbor blacklist. In this approach, after a number of acquisition failures, a failed neighbor cell 116 may be added to a failed neighbor blacklist for a certain amount of time, during which the wireless communication device 104 does not initiate an FCCH acquisition 110 or an SCH decode 112. For example, the neighbor cell may be blacklisted for a fixed duration (e.g., two minutes) after a certain number of FCCH acquisition 110 failures or SCH decode 112 failures.

The known approach results in performing unnecessary acquisitions because of the time-based nature of the approach. In general, the wireless communication device 104 can remain in stationary conditions for long periods of time. In fact, a wireless communication device 104 may be in stationary conditions for several hours each day. For example, when the user of the wireless communication device 104 is sleeping, at the workplace, at home, etc. During the time that the wireless communication device 104 is in stationary conditions, if the wireless communication device 104 has failed to successfully perform an FCCH acquisition 110 or SCH decode 112 for a neighbor cell, then it is unlikely that a successful FCCH acquisition 110 or SCH decode 112 will occur while the wireless communication device 104 remains stationary.

A wireless communication device 104 may not successfully acquire the FCCH of a failed neighbor cell 116 until the wireless communication device 104 moves to a different position. This may be due to the unchanged RF conditions over time. For example, a wireless communication device 104 may fail to acquire the FCCH or decode the SCH for an ARFCN associated with a neighbor cell. Furthermore, the wireless communication device 104 may not be able to acquire the FCCH or decode the SCH for the ARFCN until the wireless communication device 104 is moved to a different location.

According to the described systems and methods, neighbor cell FCCH acquisition 110 and SCH decode 112 may be based on mobility conditions or stationary conditions. In other words, neighbor cell FCCH acquisition 110 and SCH decode 112 for a failed neighbor cell 116 may be based on the mobility of the wireless communication device 104. A wireless communication device 104 may include an enhanced cell acquisition module 114. The enhanced cell acquisition module 114 may perform an FCCH acquisition 110 or an SCH decode 112 for a failed neighbor cell 116 based on whether the wireless communication device 104 is in mobility conditions or stationary conditions.

A mode determination module 118 may switch the wireless communication device 104 from a mobility mode to a stationary mode. The mobility of the wireless communication device 104 may be determined based on one or more parameters. In one configuration, the mode determination module 118 may switch from mobility mode to stationary mode based changes to a mode trigger flag 120. This mode trigger flag 120 can depend on one or more mode parameters 125. It should be noted that the mobility mode and the stationary mode are modes of operation for a wireless communication device 104 (e.g., UE) in idle mode. In some embodiments, the mobility mode may also be referred to as Mode 0 and the stationary mode may be referred to as Mode 1. Furthermore, mobility mode may be the legacy mode of operation for a wireless communication device 104 operating according to known GSM standards.

In one configuration, the value of the mode trigger flag 120 may be based on variation of one or more mode parameters 125. The mode parameters 125 may include one or more of a serving cell received (Rx) power, an SNR of the serving cell, an Rx power of one or more neighbor cells, an SNR of one or more neighbor cells and a change in the neighbor cell list 106. These mode parameters 125 may be based on measurements that may be obtained by the wireless communication device 104 or may be sent by the network. For example, the physical layer may obtain one or more of these measurements or may receive a system information message from the network. The mode trigger flag 120 may include one of these mode parameters 125. Alternatively, the mode trigger flag 120 may be determined based on a combination of these mode parameters 125.

In another configuration, the value of the mode trigger flag 120 may be based on changes to the neighbor cell list 106. For example, the value of the mode trigger flag 120 may be based on whether a neighbor cell is added or removed from the neighbor cell list 106. A new neighbor cell may be broadcasted by the network (e.g., the base station 102 may send a new neighbor cell list 106 with a new ARFCN).

In yet another configuration, the mode trigger flag 120 may be based on other mode parameters 125 that indicate mobility conditions or stationary conditions. Sensors may indicate that the wireless communication device 104 is mobile. One example of a sensor that indicates mobility is a GPS sensor. It should be noted that the mode trigger flag 120 may be based on one or more measurements and parameters. For example, the value of the mode trigger flag 120 may be a combination of mode parameters 125 that quantify the variation of serving cell Rx power, the variation of SNR of the serving cell, Rx power of one or more neighbor cells, SNR of one or more neighbor cells and changes to the neighbor cell list 106. When the wireless communication device 104 is in stationary conditions, these mode parameters 125 may remain constant, with only slight variation in the instantaneous values of serving cell Rx power, SNR of the serving cell, Rx power of one or more neighbor cells and SNR of one or more neighbor cells. Moreover the neighbor cell list 106 may also remain constant in stationary conditions. However, when the wireless communication device 104 is in mobility conditions, these mode parameters 125 may vary dynamically.

According to one embodiment, the mode determination module 118 may determine whether mode parameters 125 that control the value of the mode trigger flag 120 are within a stationary condition range 122 for a time period. The stationary condition range 122 for each of these mode parameters 125 may include an upper threshold and a lower threshold for these parameters. In other words, the stationary condition range 122 may be the amount of variation in the instantaneous value of these mode parameters 125 with respect to the average value of these mode parameters 125 that is permitted for the wireless communication device 104 to be considered to be in stationary conditions.

In another configuration, the stationary condition will be assessed based on whether the neighbor cell list 106 has changed (e.g., whether a neighbor cell is added or removed from the neighbor cell list 106). For example, if the neighbor cell list 106 has not changed, then this can result in the mode trigger flag 120 being set if the other mode parameters 125 are within the stationary condition range 122.

The mode determination module 118 may monitor the mode trigger flag 120 for a period of time. In one configuration, the time period may be based on a timer (e.g., a real-time timer) or a discontinuous reception (DRx) counter. The mode determination module 118 may update the mode trigger flag 120 during the time period. The mode determination module 118 may update the mode trigger flag 120 once or multiple times during the time period.

At the end of the time period, the mode determination module 118 may determine whether the mode parameters 125 on which the mode trigger flag 120 depends are within the stationary condition range 122. In one configuration, the mode determination module 118 may determine whether these mode parameters 125 are within the stationary condition range 122 at the end of the time period. In another configuration, the mode determination module 118 may determine whether these mode parameters 125 were within the stationary condition range 122 at any point throughout the entire time period.

The wireless communication device 104 may switch modes (e.g., from mobility mode to stationary mode, or from stationary mode to mobility mode) or remain in the current mode based on whether these mode parameters 125 are within the stationary condition range 122. For example, the wireless communication device 104 may switch from mobility mode to stationary mode when the mode trigger flag indicates a stationary condition after a first time period. The wireless communication device 104 may also switch from stationary mode to mobility mode when the mode trigger flag 120 indicates a mobility condition after a second time period.

In the case where these mode parameters 125 are within the stationary condition range 122, the wireless communication device 104 may switch from mobility mode to stationary mode. If the wireless communication device 104 is already in stationary mode, then the wireless communication device 104 may remain in stationary mode.

In the case where these mode parameters 125 are outside the stationary condition range 122, the wireless communication device 104 may switch from stationary mode to mobility mode. If the wireless communication device 104 is already in mobility mode, then the wireless communication device 104 may remain in mobility mode.

When the wireless communication device 104 is in mobility mode, a mobility mode module 124 may initiate FCCH acquisitions 110 and SCH decoding 112. The mobility mode module 124 may initiate FCCH acquisition 110 and SCH decode 112 based on the failed neighbor blacklist, as described above. For example, the mobility mode module 124 may add a failed neighbor cell 116 to the failed neighbor blacklist. The mobility mode module 124 may not initiate FCCH acquisition 110 and SCH decode 112 for the failed neighbor cell 116 for a certain amount of time (e.g., a blacklist time). At the expiration of the blacklist time, the mobility mode module 124 may re-initiate an FCCH acquisition 110 and SCH decode 112. This cycle of acquisition attempts followed by failed neighbor cell blacklisting may be repeated while the wireless communication device 104 is in mobility mode.

When the wireless communication device 104 switches to stationary mode, a stationary mode module 126 may initiate a combined acquisition 113 for the failed neighbor cell. The combined acquisition 113 of the neighbor cell may include at least one (or both) of a FCCH acquisition 110 and a SCH decoding 112 of the neighbor cell. If the combined acquisition 113 fails (e.g., at least one of the FCCH acquisition 110 or SCH decode 112 of the neighbor cell fails), then the stationary mode module 126 may suspend subsequent combined acquisition 113 of the neighbor cell while the wireless communication device 104 is in stationary mode. In another configuration, the stationary mode module 126 may suspend subsequent combined acquisition 113 of the neighbor cell after plurality of combined acquisition 113 failures. For example, the stationary mode module 126 may suspend subsequent combined acquisition 113 after a maximum number of combined acquisition 113 failures while in stationary mode.

It should be noted that the described systems and methods may be applied to one or more failed neighbor cells 116. As described above, the neighbor cell list 106 may include multiple neighbor cells. The wireless communication device 104 may perform FCCH acquisition 110 or SCH decode 112 for each of the failed neighbor cells 116.

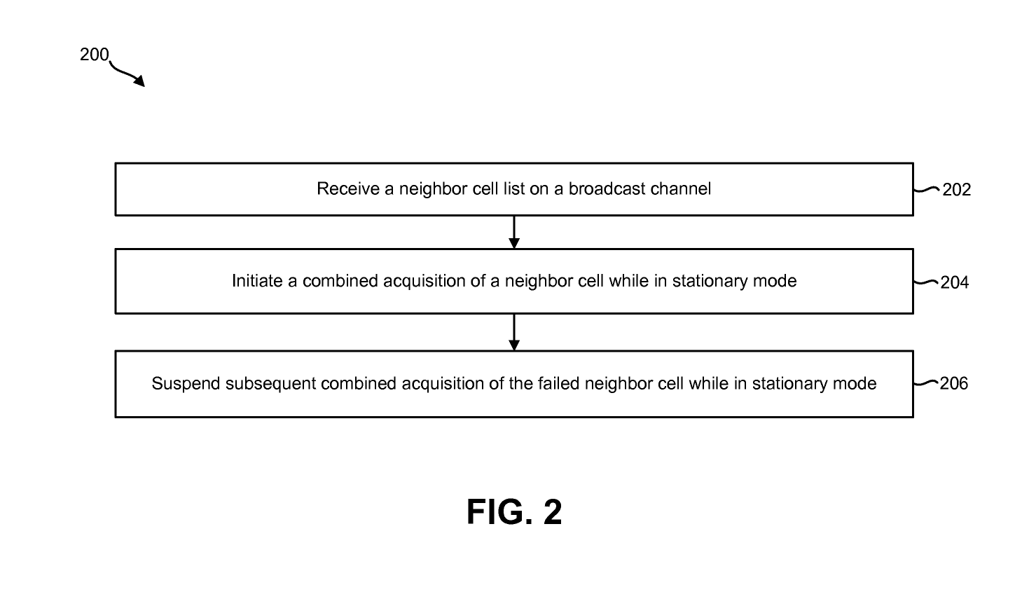

FIG. 2 is a flow diagram of a method 200 for enhanced failed cell acquisition operation according to some embodiments. The method 200 may be performed by a wireless communication device 104. In one configuration, the wireless communication device 104 may be configured according to GSM standards. The wireless communication device 104 may be operating in idle mode.

The wireless communication device 104 may receive 202 a neighbor cell list 106 on a broadcast channel. The neighbor cell list 106 may be a broadcast control channel (BCCH) allocation (BA) list that is received 202 in a BCCH system information (SI) type 2 message. The neighbor cell list 106 may include one or more neighbor cells.

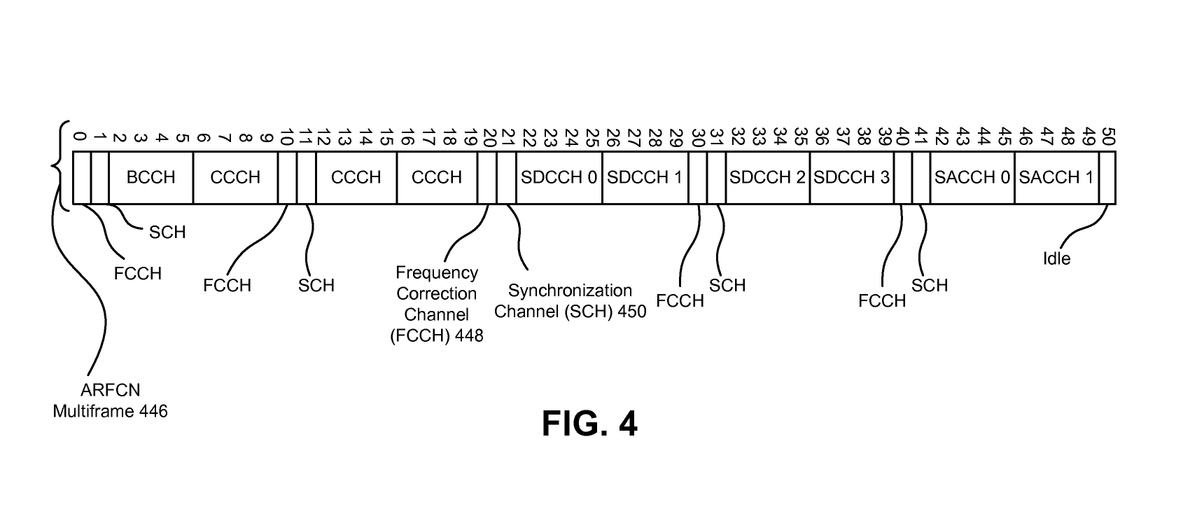

The wireless communication device 104 may initiate at least one of an FCCH acquisition 110 and an SCH decode 112 of a neighbor cell. Upon receiving the neighbor cell list 106, the wireless communication device 104 may perform an FCCH acquisition 110 and SCH decode 112 on each neighbor cell included in the neighbor cell list 106. For the FCCH acquisition 110, the wireless communication device 104 may scan an ARFCN of a neighbor cell to find the FCCH in the GSM Um air interface. The FCCH may be included in an ARFCN multiframe, as described below in connection with FIG. 4.

If the wireless communication device 104 acquires the FCCH, the wireless communication device 104 may attempt to decode the SCH of the neighbor cell. The SCH may be transmitted in a frame after the FCCH.

The wireless communication device 104 may not successfully perform FCCH acquisition 110 or SCH decode 112 for the neighbor cell. In some circumstances these failures may be due to surrounding radio frequency (RF) conditions.

The wireless communication device 104 may switch from a mobility mode to a stationary mode after a failure of at least one of the FCCH acquisition 110 or the SCH decode 112 of the neighbor cell. The neighbor cell FCCH acquisition 110 and SCH decode 112 may be based on mobility conditions or stationary conditions. If either (or both) of the FCCH acquisition 110 or the SCH decode 112 fail, then further FCCH acquisition 110 or the SCH decode 112 for the failed neighbor cell 116 may be based on whether the wireless communication device 104 is in mobility conditions or stationary conditions.

The mobility conditions and stationary conditions of the wireless communication device 104 may be determined based on one or more mode parameters 125. In one configuration, the wireless communication device 104 may switch from mobility mode to stationary mode based on changes to these mode parameters 125.

In one configuration, these mode parameters 125 may be based on one or more of a serving cell received (Rx) power, an SNR of the serving cell, an Rx power of one or more neighbor cells and an SNR of one or more neighbor cells. In another configuration, the mode trigger flag 120 may be based on changes to the neighbor cell list 106. For example, the mode trigger flag 120 may be based on whether a neighbor cell is added or removed from the neighbor cell list 106. The mode trigger flag 120 may also be based on other parameters that indicate mobility conditions or stationary conditions. For example, sensors may indicate that the wireless communication device 104 is mobile.

According to one configuration, the wireless communication device 104 may determine whether these mode parameters 125 are within a stationary condition range 122 for a time period. The stationary condition range 122 may include an upper threshold and a lower threshold for these mode parameters 125. In another configuration, the stationary condition may be whether the neighbor cell list 106 has changed (e.g., whether a neighbor cell is added or removed from the neighbor cell list 106). For example, if the neighbor cell list 106 has not changed and these mode parameters 125 are within the stationary condition range 122, then the mode trigger flag 120 will be set.

The wireless communication device 104 may monitor these mode parameters 125 for a period of time. At the end of the time period, the wireless communication device 104 may determine whether these mode parameters 125 are within the stationary condition range 122.

The wireless communication device 104 may switch modes (e.g., from mobility mode to stationary mode, or from stationary mode to mobility mode) or remain in the current mode based on whether these mode parameters 125 are within the stationary condition range 122. In the case where these mode parameters 125 are within the stationary condition range 122, the wireless communication device 104 may switch from mobility mode to stationary mode. If the wireless communication device 104 is already in stationary mode, then the wireless communication device 104 may remain in stationary mode.

In the case where these mode parameters 125 are outside the stationary condition range 122, the wireless communication device 104 may switch from stationary mode to mobility mode. If the wireless communication device 104 is already in mobility mode, then the wireless communication device 104 may remain in mobility mode.

When the wireless communication device 104 switches to stationary mode, the wireless communication device 104 may initiate 204 a combined acquisition 113 of a neighbor cell. The combined acquisition of the neighbor cell may include at least one (or both) of a frequency correction channel (FCCH) acquisition 110 and a synchronization channel (SCH) decoding 112 of the neighbor cell. In other words, the wireless communication device 104 may initiate 204 an additional FCCH acquisition 110 and an SCH decode 112 (if the FCCH acquisition 110 is successful) for the failed neighbor cell 116.

The wireless communication device 104 may perform subsequent combined acquisition 113 of the failed neighbor cell 116 based on the stationary mode and the mobility mode. If the combined acquisition 113 fails, then the wireless communication device 104 may suspend 206 subsequent combined acquisition 113 of the failed neighbor cell 116 while in stationary mode. Therefore, the wireless communication device 104 may suspend 206 further FCCH acquisition 110 and SCH decoding 112 of the failed neighbor cell 116 while in stationary mode. In one configuration, the wireless communication device 104 may suspend 206 subsequent combined acquisition 113 of the failed neighbor cell 116 after one combined acquisition 113 failure. In another configuration, the wireless communication device may suspend 206 subsequent combined acquisition 113 of the failed neighbor cell 116 after a maximum number of combined acquisition 113 failures.

The wireless communication device 104 may switch from stationary mode to mobility mode. As described above, when these mode parameters 125 are outside the stationary condition range 122, the wireless communication device 104 may switch from stationary mode to mobility mode. Upon switching to mobility mode, the wireless communication device may remove the suspension of the combined acquisition 113 of the neighbor cell. While in mobility mode, the wireless communication device 104 may perform combined acquisition 113 according to legacy operation.

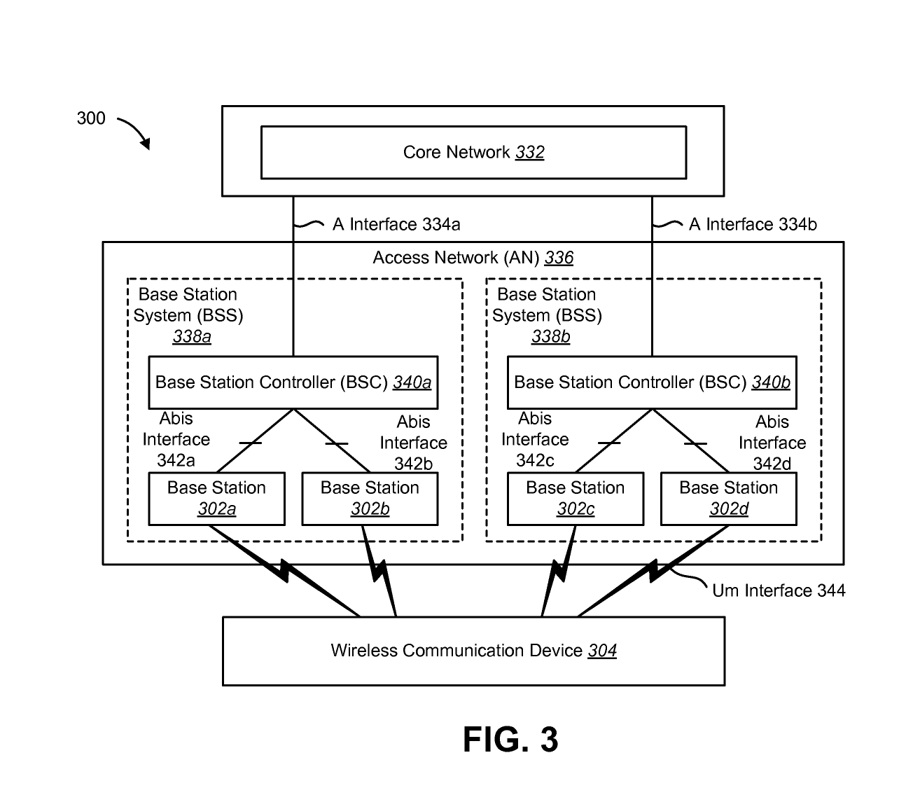

FIG. 3 is a block diagram illustrating a radio network 300 operating according to embodiments of the present invention. The radio network 300 may operate according to Global System for Mobile Communications (GSM) standards and may be referred to as a GSM network. A GSM network is a collective term for the base stations 302a-d and the control equipment for the base stations 302a-d (e.g., base station controllers (BSCs) 340a-b) the GSM network may contain, which make up the access network (AN) 336. The GSM network provides an air interface access method for the wireless communication device 304. Connectivity is provided between the wireless communication device 304 and the core network 332 by the GSM network. The access network (AN) 336 may transport data packets between multiple wireless communication devices 304.

The GSM network is connected internally or externally to other functional entities by various interfaces (e.g., an A interface 334a-b, an Abis interface 342a-d, and a Um interface 344). The GSM network is attached to a core network 332 via an external interface (e.g., an A interface 334a-b). The base station controllers (BSCs) 340a-b support this interface. In addition, the base station controllers (BSCs) 340a-b manage a set of base stations 302a-d through Abis interfaces 342a-d. A base station controller (BSC) 340a and the managed base stations 302a-b form a base station system (BSS) 338a. A base station controller (BSC) 340b and the managed base stations 302c-d form a base station system (BSS) 338b. The Um interface 344 connects a base station 302 with a wireless communication device 304, while the Abis interface 342 is an internal interface connecting the base station controller (BSC) 340 with the base station 302.

The radio network 300 may be further connected to additional networks outside the radio network 300, such as a corporate intranet, the Internet or a conventional public switched telephone network. The radio network 300 may transport data packets between each wireless communication device 304 and such outside networks.

GSM is a widespread standard in cellular, wireless communication. GSM is relatively efficient for standard voice services. However, high-fidelity audio and data services may require higher data throughput rates than that for which GSM is optimized. To increase capacity, the General Packet Radio Service (GPRS), EDGE (Enhanced Data rates for GSM Evolution) and UMTS (Universal Mobile Telecommunications System) standards have been adopted in GSM systems. In the GSM/EDGE Radio Access Network (GERAN) specification, GPRS and EGPRS provide data services. The standards for GERAN are maintained by the 3GPP (Third Generation Partnership Project). GERAN is a part of GSM. More specifically, GERAN is the radio part of GSM/EDGE together with the network that joins the base stations 102 (the Ater and Abis interfaces 342a-d) and the base station controllers (A interfaces 334a-b, etc.). GERAN represents the core of a GSM network. It routes phone calls and packet data from and to the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM networks typically operate in a number of frequency bands. For example, a GSM network may use the GSM-850 band, the EGSM band (also referred to as the E-GSM-900 band), the DCS (digital cellular service) band (also referred to as DCS-1800), the PCS (personal communications service) band (also referred to as PCS-1900), the P-GSM band, the R-GSM band and the T-GSM band. Due to refarming, many additional GSM bands may also be employed that have not yet been defined.

For uplink 127 communication, GSM-900 commonly uses a radio spectrum in the 890-915 megahertz (MHz) bands (wireless communication device 304 to base station 302). For downlink 129 communication, GSM-900 uses 935-960 MHz bands (base station 302 to wireless communication device 304). Furthermore, each frequency band is divided into 200 kHz carrier frequencies providing 124 RF channels spaced at 200 kHz. GSM-1900 uses the 1850-1910 MHz bands for the uplink 114 and 1930-1990 MHz bands for the downlink 129. Like GSM-900, FDMA divides the spectrum for both uplink 127 and downlink 129 into 200 kHz-wide carrier frequencies. Similarly, GSM-850 uses the 824-849 MHz bands for the uplink 127 and 869-894 MHz bands for the downlink 129, while GSM-1800 uses the 1710-1785 MHz bands for the uplink 127 and 1805-1880 MHz bands for the downlink 129.

As described above, each channel in GSM is identified by a specific absolute radio frequency channel (ARFCN). For example, ARFCN 1-124 are assigned to the channels of GSM-900, while ARFCN 512-810 are assigned to the channels of GSM-1900. Similarly, ARFCN 128-251 are assigned to the channels of GSM-850, while ARFCN 512-885 are assigned to the channels of GSM-1800.

FIG. 4 illustrates an ARFCN multiframe 446 according to some embodiments. The ARFCN multiframe 446 may be from a scanned ARFCN that is determined to include a frequency correction channel (FCCH) 448. Because the ARFCN multiframe 446 includes a frequency correction channel (FCCH) 448, the ARFCN multiframe 446 also includes a synchronization channel (SCH) 450 that immediately follows the frequency correction channel (FCCH) 448.

The ARFCN multiframe 446 may include a 67 kHz tone (which is the FCCH 448) that is repeated approximately every 50 ms. Once the FCCH is found (e.g., acquired), the next frame (4.6 ms later) will be the synchronization channel (SCH). The ARFCN multiframe 446 may also include other information, such as the broadcast control channel (BCCH), the common control channel (CCCH), the stand-alone dedicated control channel (SDCCH) and the slow associated control channel (SACCH).

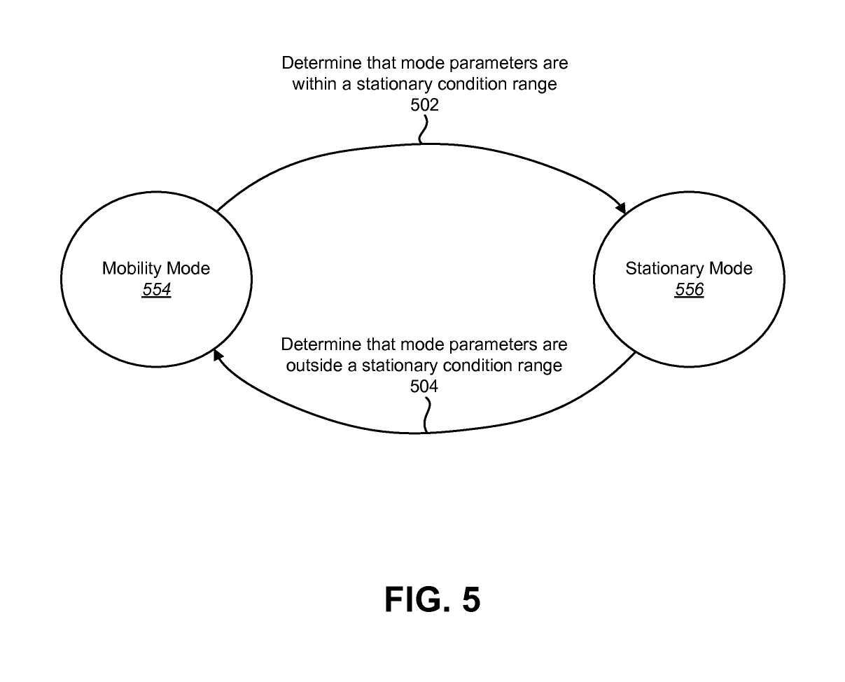

FIG. 5 is a state diagram illustrating transition between a mobility mode 554 and a stationary mode 556. It should be noted that the mobility mode 554 and the stationary mode 556 are modes of operation for the idle mode. While in idle mode, a wireless communication device 104 may switch between mobility mode 554 and stationary mode 556. When the wireless communication device 104 is in mobility conditions, the wireless communication device 104 may operate in mobility mode 554. When the wireless communication device 104 is in stationary conditions, the wireless communication device 104 may operate in stationary mode 556.

A wireless communication device 104 may be in mobility conditions when the wireless communication device 104 is moving. A wireless communication device 104 may be in stationary conditions when the wireless communication device 104 is stationary (e.g., not moving) or when movement is minimal. The amount of motion of the wireless communication device 104 that indicates mobility (or stability) may be based on an amount of motion over a period of time. The amount of motion may be relative to the serving cell or neighbor cells. For example, if the wireless communication device 104 moves at least a certain amount in the period of time, then the wireless communication device 104 may be considered to be in mobility conditions. However, if the wireless communication device 104 remains motionless, moves only slightly or moves only within a small area (relative to the serving cell or neighbor cells), then the wireless communication device 104 may be considered to be in stationary conditions. It should be noted that the amount of motion and the time period may vary based on implementations of the described systems and methods.

Mobility conditions and stationary conditions may be monitored based on mode parameters 125 that set a mode trigger flag 120. In one configuration, the mode trigger flag 120 may be based on one or more mode parameters 125. The mode parameters 125 may include one or more of a serving cell Rx power, an SNR of the serving cell, an Rx power of one or more neighbor cells, an SNR of one or more neighbor cells and change in the neighbor cell list 106. These mode parameters 125 may indicate whether the wireless communication device 104 is moving or stationary. The mode trigger flag 120 may be based on one of these mode parameters 125. Alternatively, the mode trigger flag 120 may be based on a combination of these mode parameters 125. In one example, the mode trigger flag 120 may be determined according to the pseudocode of Listing (1).

Listing (1)

```
Mode_Trigger_Flag = S_Rx_power_Parameter &&
S_SNR_Parameter
    && N1_Rx_power_Parameter && N1_SNR_Parameter
    && Nk_Rx_power_Parameter && Nk_SNR_Parameter
    && No_Change_in_BA
Where
if {S_Rx_power_Avg − Offset_S_Rx_power <
S_Rx_power_Instantaneous < ...
    S_Rx_power_Avg + Offset_S_Rx_power }
    S_Rx_power_Parameter = TRUE
else
    S_Rx_power_Parameter = FALSE
if {S_SNR_Avg − Offset_S_SNR<S_SNR_Instantaneous <
    S_SNR_Avg + ... Offset_S_SNR}
    S_SNR_Parameter = TRUE
else
    S_SNR_Parameter = FALSE
For z = 1:k
{
    if {Nz_Rx_power_Avg − Offset_Nz_Rx_power < ...
        Nz_Rx_power_Instantaneous < Nz_Rx_power_Avg + ...
        Offset_Nz_Rx_power }
        Nz_Rx_power_Parameter = TRUE
    else
        Nz_Rx_power_Parameter = FALSE
    if {Nz_SNR_Avg −
    Offset_Nz_SNR<S_SNR_Instantaneous < ...
        Nz_SNR_Avg + Offset_Nz_SNR}
        Nz_SNR_Parameter = TRUE
    else
        Nz_SNR_Parameter = FALSE
}
if {Neighbor Cell List has NOT changed }
    No_Change_in_BA = TRUE
else
    No_Change_in_BA = FALSE
```

In the pseudocode of Listing (1), Mode_Trigger_Flag=TRUE implies that the wireless communication device 104 is stationary, otherwise the wireless communication device 104 is not stationary. The Mode_Trigger_Flag is the mode trigger flag 120, S_Rx_power_Avg is the average serving cell Rx power, S_Rx_power_Instantaneous is the instantaneous serving cell Rx power, S_SNR_Avg is the average SNR of the serving cell, S_SNR_Instantaneous is the instantaneous SNR of the serving cell, Nz_Rx_power_Avg is the average Rx power of the z′th neighbor cell, Nz_Rx_power_Instantaneous is the instantaneous Rx power of the z′th neighbor cell, Nz_SNR_Avg is the average SNR of the z′th neighbor cell, Nz_SNR_Instantaneous is the instantaneous SNR of the z′th neighbor cell and No_Change_in_BA flag indicates whether or not the BA List (e.g., neighbor cell list 106) has changed. Note that z ranges from 1 to k, so there can be one or more neighbor cell measurements that can be used to determine the value of the Mode_Trigger_Flag. It should also be noted that the Rx power and the SNR for one or more neighbor cells may be used in Listing (1). The “&&” symbol is an AND operator. The term “offset” indicates the allowable variation of the respective parameter in stationary conditions. In Listing (1), the value of the mode trigger flag 120 may depend on any one of the serving cell Rx power, the SNR of the serving cell, the neighbor cell(s) Rx power, the SNR of the neighbor cell(s) and the change in the BA list.

In another configuration, the mode trigger flag 120 may be based on changes to the neighbor cell list 106. For example, the mode trigger flag 120 may be based on whether a neighbor cell is added or removed from the neighbor cell list 106.

The mode trigger flag 120 may also be based on other parameters that indicate mobility conditions or stationary conditions. Sensors may indicate that the wireless communication device 104 is mobile. One example of a sensor that indicates mobility is a GPS sensor.

When the wireless communication device 104 is in stationary conditions the mode parameters 125 on which the mode trigger flag 120 depends may remain constant, with slight variation. However, when the wireless communication device 104 is in mobility conditions, the mode parameters 125 may have significant variation.

According to one embodiment, the wireless communication device 104 may determine whether the mode parameters 125 are within a stationary condition range 122 for a time period. The mode trigger flag 120 may be set to a specific value based on the stationary condition range 122. When the mode parameters 125 are based on the serving cell Rx power, an SNR of the serving cell, an Rx power of one or more neighbor cells and an SNR of one or more neighbor cells, the stationary condition range 122 may include an upper threshold and a lower threshold for the mode parameters 125. The wireless communication device 104 may monitor the mode parameters 125 for a period of time. At the end of the time period, the wireless communication device 104 may determine whether the mode parameters 125 are within the stationary condition range 122. This may be accomplished according to Equation (1).

Lower Threshold<Mode Parameter<Upper Threshold (1)

In this case, the wireless communication device 104 may evaluate each measurement (e.g., the serving cell Rx power, the SNR of the serving cell, the Rx power of one or more neighbor cells and the SNR of one or more neighbor cells) individually according to Equation (1). If each of the measurements satisfies Equation (1) (e.g., Equation (1) is true for each of the measurements), then the respective mode parameter 125 is within the stationary condition range 122. However, if one or more of the measurements does not satisfy Equation (1) (e.g., Equation (1) is false for at least one measurement), then the mode trigger flag 120 will be FALSE; indicating that the wireless communication device 104 is outside the stationary condition range 122.

When the mode trigger flag 120 is based on changes to the neighbor cell list 106, the wireless communication device 104 may monitor the mode trigger flag 120 for a period of time to determine whether a neighbor cell is added or removed from the neighbor cell list 106. In this case, if the neighbor cell list 106 has not changed, then the mode trigger flag 120 will indicate stationary conditions. However, if one or more neighbor cells are added or removed from the neighbor cell list 106, then the mode trigger flag 120 will be FALSE; indicating that the wireless communication device 104 is outside the stationary condition range 122.

The wireless communication device 104 may switch modes (e.g., from mobility mode 554 to stationary mode 556, or from stationary mode 556 to mobility mode 554) or remain in the current mode based on whether the mode parameters 125 are within or outside the stationary condition range 122. If the wireless communication device 104 determines 502 that the mode parameters 125 are within the stationary condition range 122, the wireless communication device 104 may switch from mobility mode 554 to stationary mode 556. If the wireless communication device 104 is already in stationary mode 556, then the wireless communication device 104 may remain in stationary mode 556.

If the wireless communication device 104 determines 504 that the mode parameters 125 are outside the stationary condition range, the wireless communication device 104 may switch from stationary mode 556 to mobility mode 554. If the wireless communication device 104 is already in mobility mode 554, then the wireless communication device 104 may remain in mobility mode 554.

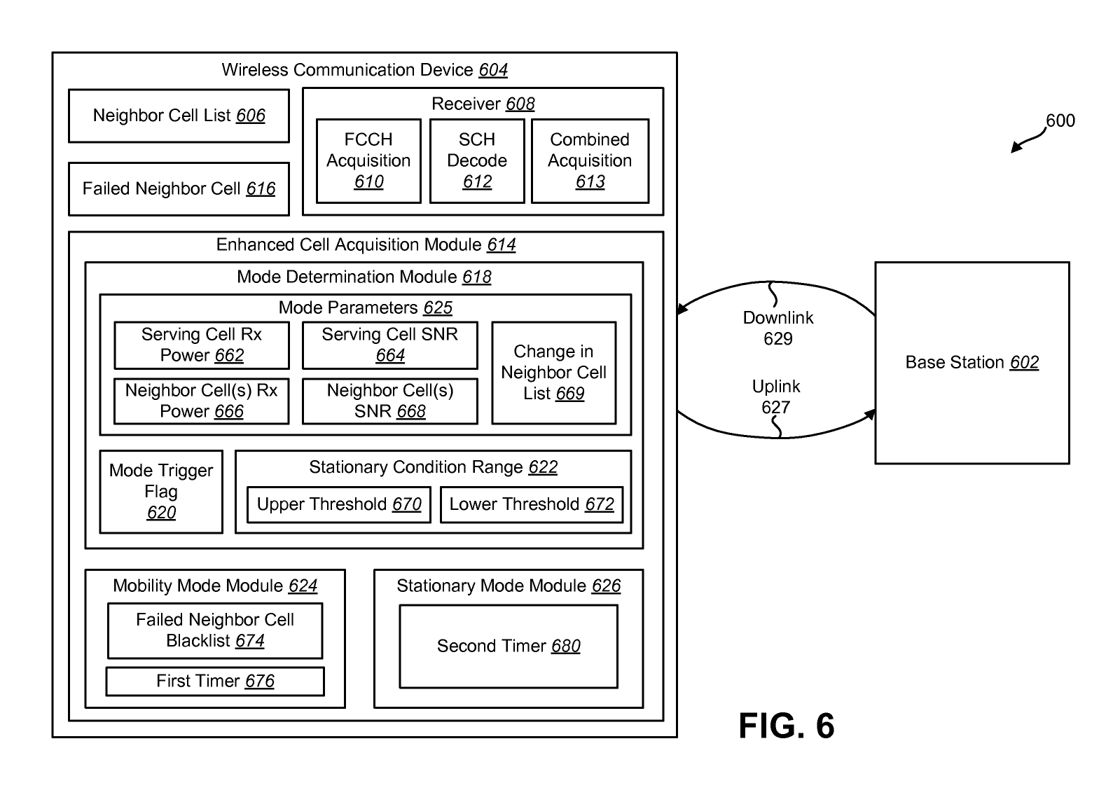

FIG. 6 is a block diagram illustrating a more detailed embodiment of a wireless communication system 600 with multiple wireless devices in which systems and methods for enhanced failed cell acquisition operation may be implemented. The wireless communication system 600 may include one or more wireless communication devices 604 and one or more base stations 602. The wireless communication device 604 may be implemented in accordance with the wireless communication device 104 as described above in connection with FIG. 1. The wireless communication device 604 may communicate with a base station 602 via a downlink 629 and an uplink 627. A base station 602 may be located in a wireless communication system 600 operating according to GSM standards.

The wireless communication device 604 may receive a neighbor cell list 606 on a broadcast channel. The neighbor cell list 606 may be a broadcast control channel (BCCH) allocation (BA) list that is received in a BCCH system information (SI) type 2 message. The neighbor cell list 606 may include one or more neighbor cells.

Upon receiving the neighbor cell list 606, the wireless communication device 604 may initiate an FCCH acquisition 610 and SCH decode 612 on each neighbor cell included in the neighbor cell list 606. For the FCCH acquisition 610, the receiver 608 of the wireless communication device 604 may scan an ARFCN of a neighbor cell to find the FCCH 448 in the GSM Um air interface. The FCCH 448 may be included in an ARFCN multiframe 446, as described above in connection with FIG. 4.

If the wireless communication device 604 acquires the FCCH 448, the wireless communication device 604 may attempt to decode the SCH 450 of the neighbor cell. The SCH 450 may be transmitted in a frame after the FCCH 448, as described above in connection with FIG. 4. In one configuration, the receiver 608 may attempt to decode the SCH 450 of the neighbor cell.

The wireless communication device 604 may include an enhanced cell acquisition module 614 to implement enhanced failed cell acquisition according to the described systems and methods. The enhanced cell acquisition module 614 may perform combined acquisition 613 of a failed neighbor cell 616 based on whether the wireless communication device 604 is in mobility conditions or stationary conditions. As described above, a combined acquisition 613 may include performing at least one (or both) of an FCCH acquisition 610 and an SCH decode 612 of a neighbor cell.

A mode determination module 618 may switch the wireless communication device 604 from a mobility mode 554 to a stationary mode 556. In one configuration, the mobility of the wireless communication device 604 may be determined based on a mode trigger flag 620. The mode determination module 618 may switch from mobility mode 554 to stationary mode 556 based on changes to the mode trigger flag 620. In one configuration, the mode trigger flag 620 may be based on one or more mode parameters 625. The mode parameters 625 may include one or more of a serving cell Rx power 662, a serving cell SNR 664, neighbor cell(s) Rx power 666 and neighbor cell(s) SNR 668. In another configuration, the mode trigger flag 620 may be based on a change in the neighbor cell list 669.

The mode determination module 618 may determine whether the mode parameters 625 are within a stationary condition range 622 for a time period. The stationary condition range 622 may include an upper threshold 670 and a lower threshold 672 for the mode parameters 625. The mode determination module 618 may monitor the mode parameters 625 for a period of time. In one configuration, the time period may be based on a timer (e.g., a first timer 676 or a second timer 680).

The mode determination module 618 may determine whether the mode parameters 625 are within the stationary condition range 622. The wireless communication device 604 may switch modes (e.g., from mobility mode 554 to stationary mode 556, or from stationary mode 556 to mobility mode 554) or remain in the current mode based on whether the mode parameters 625 are within the stationary condition range 622.

If the mode trigger flag 620 is based on one or more of the serving cell Rx power 662, the serving cell SNR 664, neighbor cell(s) Rx power 666 and neighbor cell(s) SNR 668, the mode determination module 618 may evaluate the mode parameters 625 according to Equation (1), as described in connection with FIG. 4. If Equation (1) is true for each of one or more measurements, then the mode trigger flag 620 indicates that the wireless communication device 604 is within the stationary condition range 622.

If the mode trigger flag 620 is based on a change in the neighbor cell list 669, the mode determination module 618 may determine whether the neighbor cell list 606 does not change during the time period. If there are no changes to the neighbor cell list 606 for the time period, then the mode trigger flag 620 indicates that the wireless communication device 604 is within the stationary condition range 622.

If the mode trigger flag 620 indicates that the wireless communication device 604 is within the stationary condition range 622, the wireless communication device 604 may switch from mobility mode 554 to stationary mode 556. If the wireless communication device 604 is already in stationary mode 556, then the wireless communication device 604 may remain in stationary mode 556.

In the case where the mode trigger flag 620 indicates that the wireless communication device 604 is outside the stationary condition range 622, the wireless communication device 604 may switch from stationary mode 556 to mobility mode 554. If the wireless communication device 604 is already in mobility mode 554, then the wireless communication device 604 may remain in mobility mode 554.

The mobility mode module 624 may perform combined acquisition 613 of a failed neighbor cell 616 according to legacy operation. In one configuration, the mobility mode module 624 may initiate FCCH acquisition 610 and SCH decoding 612 based on a failed neighbor blacklist 674. This may be accomplished as described above in connection with FIG. 1. For example, after a number of failed FCCH acquisition 610 attempts and SCH decode 612 attempts, the wireless communication device 604 may blacklist a failed neighbor cell 616 for a period of time. While the failed neighbor cell 616 is on the failed neighbor blacklist 674, the wireless communication device 604 does not perform FCCH acquisition 610 and SCH decoding 612. After the blacklisting time has expired, the wireless communication device 604 may resume FCCH acquisition 610 and SCH decoding 612 attempts for the failed neighbor cell 616.

Upon switching to mobility mode 554, the mobility mode module 624 may start a first timer 676. While the first timer 676 is running, the mode determination module 618 may monitor (e.g., update) the mode parameters 625. Upon the expiration of the first timer 676, the mode determination module 618 may determine whether the mode parameters 625 are within the stationary condition range 622. If the mode parameters 625 are outside the stationary condition range 622, then the wireless communication device 604 may continue to operate in mobility mode 554 and the first timer 676 may be restarted. If the mode parameters 625 are within the stationary condition range 622, then the wireless communication device 604 may switch to stationary mode 556.

When the wireless communication device 604 switches to stationary mode 556, the stationary mode module 626 may initiate a combined acquisition 613 of the failed neighbor cell 616. In other words, the stationary mode module 626 may initiate an FCCH acquisition 610 and an SCH decode 612 (if the FCCH acquisition 610 is successful) for the failed neighbor cell 616. If the combined acquisition 613 fails, then stationary mode module 626 may suspend subsequent combined acquisition 613 of the failed neighbor cell 616 while the wireless communication device 604 is in stationary mode 556.

Upon switching to stationary mode 556, the stationary mode module 626 may start a second timer 680. While the second timer 680 is running, the mode determination module 616 may update the mode trigger flag 620 based on the measurements and parameters associated with the mode trigger flag 620. Upon the expiration of the second timer 680, the mode determination module 616 may determine whether the mode trigger flag 620 indicates that the wireless communication device 604 is within the stationary condition range 622. If the mode trigger flag 620 indicates that the wireless communication device 604 is within the stationary condition range 622, then the wireless communication device 604 may continue to operate in stationary mode 556 and the second timer 680 may be restarted. If the mode trigger flag 620 indicates that the wireless communication device 604 is outside the stationary condition range 622, then the wireless communication device 604 may remove the suspension of the combined acquisition 613 of the neighbor cell and switch to mobility mode 554.

In one example, the wireless communication device 604 may be camped on a serving cell. The wireless communication device 604 may be in mobility mode 554. One of the mode parameters 625 may be based on an average serving cell receive power 662. The wireless communication device 604 may measure the serving cell receive power 662 at −60 decibels referenced to milliwatt (dBm). In this example, the offset is 3 dBm. Therefore, the stationary condition range 622 is defined by a lower threshold 672 of −63 dBm and an upper threshold 670 of −57 dBm. If the mode parameter 625 is within the stationary condition range 622 for the duration of the first timer 676, then the wireless communication device 604 may switch from mobility mode 554 to stationary mode 556. Upon switching to stationary mode 556, the second timer 680 is started. Upon expiration of the second timer 680, if the mode parameter 625 is outside the stationary condition range 622 (e.g., if the instantaneous serving cell receive power 662 is less than −63 dBm or greater than −57 dBm), then the wireless communication device 604 may switch from stationary mode 556 to mobility mode 554.

Similar evaluations may be performed for the serving cell SNR 664, the neighbor cell(s) Rx power 666 and the neighbor cell(s) SNR 668. If any of these mode parameters 625 are outside the stationary condition range 622, then the wireless communication device 604 may switch to mobility mode 554.

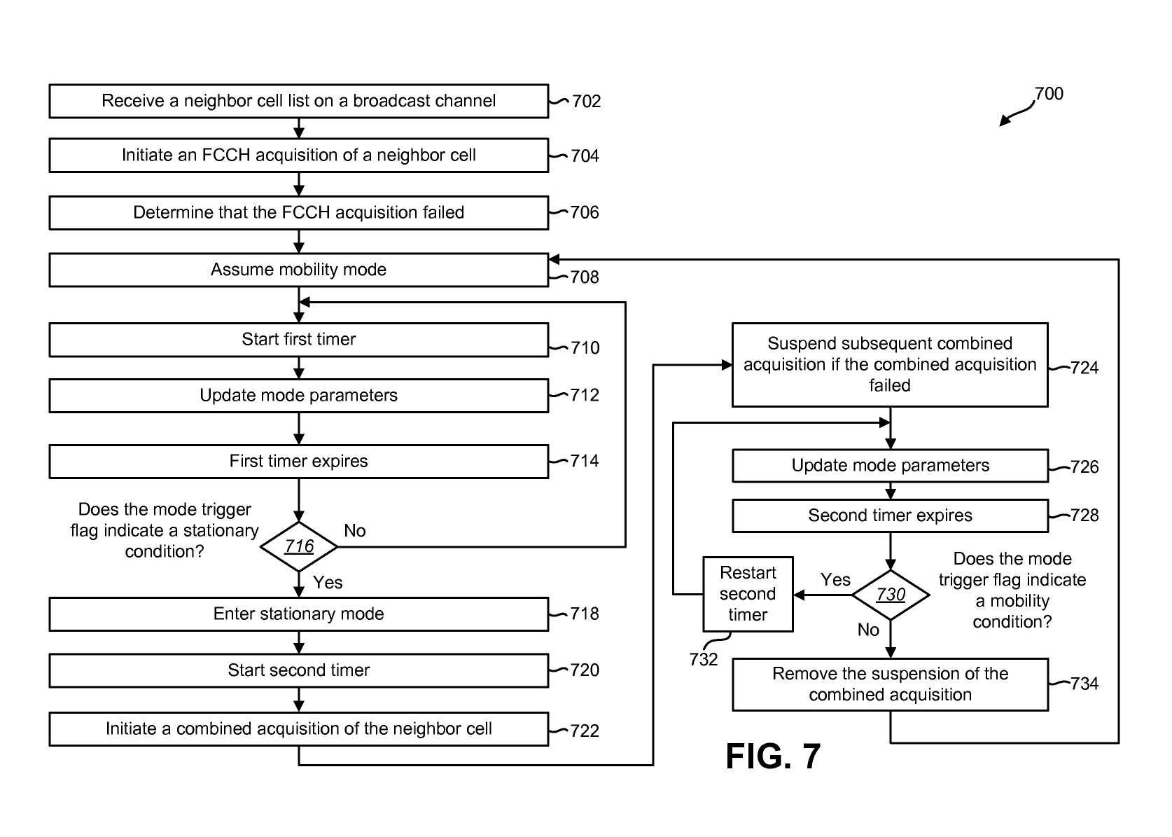

FIG. 7 is a flow diagram of a method 700 for another embodiment of enhanced failed cell acquisition operation. The method 700 may be performed by a wireless communication device 604. In one configuration, the wireless communication device 604 may be configured according to GSM standards. The wireless communication device 604 may be operating in idle mode.

The wireless communication device 604 may receive 702 a neighbor cell list 606. The neighbor cell list 606 may be received 702 on a broadcast channel. The neighbor cell list 106 may be a broadcast control channel (BCCH) allocation (BA) list that is received 702 in a BCCH system information (SI) type 2 message. The neighbor cell list 606 may include one or more neighbor cells.

The wireless communication device 604 may initiate 704an FCCH acquisition 610 of a neighbor cell. This may be accomplished as described above, in connection with FIG. 1.

The wireless communication device 604 may determine 706 that the FCCH acquisition 610 failed. For example, the wireless communication device 604 may fail to find the FCCH 448 on an ARFCN multiframe 446 of the neighbor cell. Furthermore, the FCCH acquisition 610 may fail as a result of SCH decode 612 failure due to one or more CRC failures.

The wireless communication device 604 may assume 708 mobility mode 554. The wireless communication device 604 may start 710 a first timer 676. While in mobility mode 554, the wireless communication device 604 may perform combined acquisition 613 of the failed neighbor cell 616 according to legacy operation. For example, the wireless communication device 604 may perform FCCH acquisition 610 and SCH decode 612 based on a failed neighbor cell blacklist 674, as described above in connection with FIG. 1.

The wireless communication device 604 may update 712 the mode parameters 625 while the first timer 676 is running. For example, the wireless communication device 604 may update 712 the mode parameters 625 based on the measurements and parameters (e.g., serving cell Rx power 662, serving cell SNR 664, neighbor cell(s) Rx power 666, neighbor cell(s) SNR 668 or change in the neighbor cell list 669) associated with the mode trigger flag 620.

Upon expiration 714 of the first timer 676, the wireless communication device 604 may determine 716 whether a mode trigger flag 620 indicates a stationary condition. For example, the wireless communication device 604 may determine 716 that the wireless communication device 604 is within the stationary condition range 622. If the mode trigger flag 620 indicates that the wireless communication device 604 is not within the stationary condition range 622, then the wireless communication device 604 remains in mobility mode 554 and restarts 710 the first timer 676.

If the wireless communication device 604 determines 716 that the mode trigger flag 620 indicates a stationary condition (e.g., the wireless communication device 604 is within the stationary condition range 622), then the wireless communication device 604 enters 718 (e.g., switches to) stationary mode 556. The wireless communication device 604 may start 720 a second timer 680. The wireless communication device 604 may initiate 722 a combined acquisition 613 of the neighbor cell. If the combined acquisition 613 fails, then the wireless communication device 604 may suspend 724 subsequent combined acquisition 613 while the wireless communication device 604 is in stationary mode 556. In other words, while the wireless communication device 604 is in stationary mode 556, the wireless communication device may not perform additional FCCH acquisition 610 or SCH decoding 612.

The wireless communication device 604 may update 726 the mode parameters 625 while the second timer 680 is running. For example, the wireless communication device 604 may update 726 the mode parameters 625 based on the measurements and parameters (e.g., serving cell Rx power 662, serving cell SNR 664, neighbor cell(s) Rx power 666, neighbor cell(s) SNR 668 or change in the neighbor cell list 669) associated with the mode trigger flag 620.

Upon expiration 728 of the second timer 680, the wireless communication device 604 may determine 730 whether the mode trigger flag 620 indicates a mobility condition. If the mode trigger flag 620 indicates that the wireless communication device 604 is within the stationary condition range 622, the wireless communication device 604 may restart 732 the second timer 680 and continue operating in stationary mode 556. If the wireless communication device 604 determines 730 that the mode trigger flag 620 indicates that the wireless communication device 604 is not within (e.g., is outside) the stationary condition range 622, then the wireless communication device 604 may remove 734 the suspension of the combined acquisition 613 and may assume 708 (e.g., switch to) mobility mode 554. Because the wireless communication device 604 removes 734 the suspension of the combined acquisition 613, the wireless communication device 604 may perform combined acquisition 613 according to legacy operation while in mobility mode.

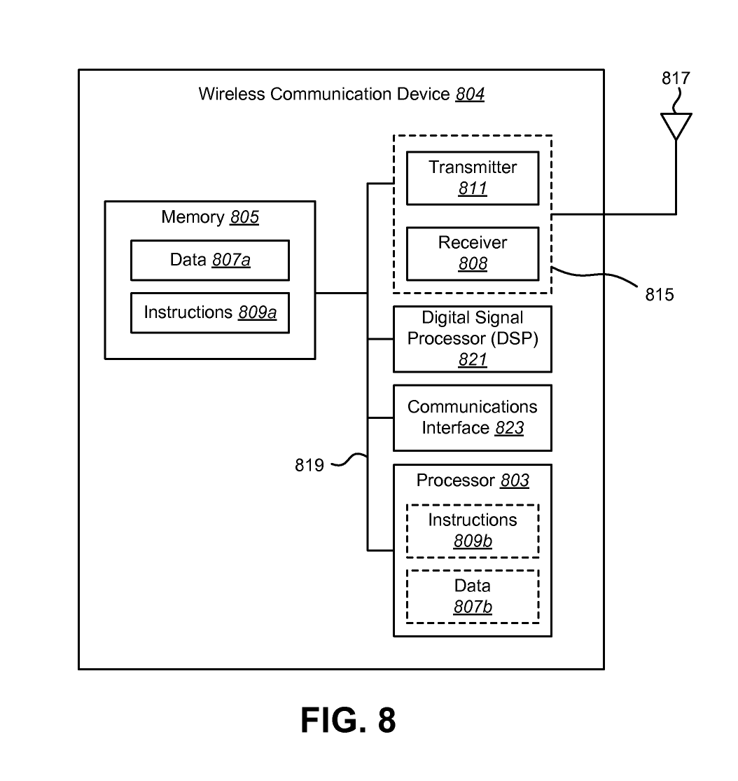

FIG. 8 illustrates certain components that may be included within a wireless communication device 804 according to some embodiments. The wireless communication device 804 may be an access terminal, a mobile station, a user equipment (UE), etc. The wireless communication device 804 includes a processor 803. The processor 803 may be a general purpose single- or multi-chip (e.g., an Advanced RISC (Reduced Instruction Set Computer) Machine (ARM)), a special purpose microprocessor (e.g., a digital signal processor (DSP)), a microcontroller, a programmable gate array, etc. The processor 803 may be referred to as a central processing unit (CPU). Also, as is known by those skilled in the art, the processor 803 can be comprised of one or more of circuits, circuitry, partitioned memory, control unit, and the like. Still yet, the processor 803 may include input/output ports, memory buffers, and an ALU for performing instructions and data manipulation. Although just a single processor 803 is shown in the wireless communication device 804 of FIG. 8, in an alternative configuration, a combination of processors (e.g., an ARM and DSP) could be used.

The wireless communication device 804 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809, various portions of the instructions 809b may be loaded onto the processor 803, and various pieces of data 807b may be loaded onto the processor 803.

The wireless communication device 804 may also include a transmitter 811 and a receiver 808 to allow transmission and reception of signals to and from the wireless communication device 804 via an antenna 817. The transmitter 811 and receiver 808 may be collectively referred to as a transceiver 815. The wireless communication device 804 may also include (not shown) multiple transmitters, multiple antennas, multiple receivers and/or multiple transceivers.

The wireless communication device 804 may include a digital signal processor (DSP) 821. The wireless communication device 804 may also include a communications interface 823. The communications interface 823 may allow a user to interact with the wireless communication device 804.

The various components of the wireless communication device 804 may be coupled together by one or more buses, which may include a power bus, a control signal bus, a status signal bus, a data bus, etc. For the sake of clarity, the various buses are illustrated in FIG. 8 as a bus system 819.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 2 and 7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized. For example, some of the methods described herein may be performed by a processor 803, one or more local oscillators (LOs), a wideband receiver fast Fourier transform (FFT) hardware, software and/or firmware.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for wireless communication, comprising:
performing subsequent combined acquisition of a neighbor cell based on a stationary mode and a mobility mode.

2. The method of claim 1, wherein the combined acquisition of the neighbor cell comprises at least one of a frequency correction channel (FCCH) acquisition and a synchronization channel (SCH) decoding of the neighbor cell.

3. The method of claim 1, further comprising suspending subsequent combined acquisition of the neighbor cell after one combined acquisition failure or a plurality of combined acquisition failures while in stationary mode.

4. The method of claim 1, further comprising:
switching to mobility mode; and
removing a suspension of the combined acquisition of the neighbor cell.

5. The method of claim 1, further comprising switching from stationary mode to mobility mode based on changes to a mode trigger flag.

6. The method of claim 5, wherein the mode trigger flag is based on variation of at least one of:
a serving cell receive power,
a serving cell signal to noise ratio,
a receive power of one or more neighbor cells,
a signal to noise ratio of one or more neighbor cells, and
a change in a neighbor cell list.

7. The method of claim 5, further comprising:
switching from mobility mode to stationary mode when the mode trigger flag indicates a stationary condition after a first time period; and
switching from stationary mode to mobility mode when the mode trigger flag indicates a mobility condition after a second time period.

8. The method of claim 1, further comprising:
receiving a neighbor cell list on a broadcast channel;
initiating a frequency correction channel (FCCH) acquisition of a neighbor cell while in mobility mode;
switching from the mobility mode to the stationary mode after a failure of the FCCH acquisition of the neighbor cell based on changes to a mode trigger flag; and
initiating a combined acquisition of a neighbor cell while in stationary mode.

9. An apparatus for wireless communication, comprising:
a processor;
memory in electronic communication with the processor; and
instructions stored in the memory, the instructions being executable by the processor to:
perform subsequent combined acquisition of a neighbor cell based on a stationary mode and a mobility mode.

10. The apparatus of claim 9, wherein the combined acquisition of the neighbor cell comprises at least one of a frequency correction channel (FCCH) acquisition and a synchronization channel (SCH) decoding of the neighbor cell.

11. The apparatus of claim 9, further comprising instructions executable to suspend subsequent combined acquisition of the neighbor cell after one combined acquisition failure or a plurality of combined acquisition failures while in stationary mode.

12. The apparatus of claim 9, further comprising instructions executable to:
switch to mobility mode; and
remove a suspension of the combined acquisition of the neighbor cell.

13. The apparatus of claim 9, further comprising instructions executable to switch from stationary mode to mobility mode based on changes to a mode trigger flag.

14. The apparatus of claim 13, wherein the mode trigger flag is based on variation of at least one of:
a serving cell receive power,
a serving cell signal to noise ratio,
a receive power of one or more neighbor cells,
a signal to noise ratio of one or more neighbor cells, and
a change in a neighbor cell list.

15. The apparatus of claim 13, further comprising instructions executable to:
switch from mobility mode to stationary mode when the mode trigger flag indicates a stationary condition after a first time period; and
switch from stationary mode to mobility mode when the mode trigger flag indicates a mobility condition after a second time period.

16. The apparatus of claim 9, further comprising instructions executable to:
receive a neighbor cell list on a broadcast channel;
initiate a frequency correction channel (FCCH) acquisition of a neighbor cell while in mobility mode;
switch from the mobility mode to the stationary mode after a failure of the FCCH acquisition of the neighbor cell based on changes to a mode trigger flag; and
initiate a combined acquisition of a neighbor cell while in stationary mode.

17. A wireless device, comprising:
means for performing subsequent combined acquisition of a neighbor cell based on a stationary mode and a mobility mode.

18. The wireless device of claim 17, wherein the combined acquisition of the neighbor cell comprises at least one of a frequency correction channel (FCCH) acquisition and a synchronization channel (SCH) decoding of the neighbor cell.

19. The wireless device of claim 17, further comprising means for suspending subsequent combined acquisition of the neighbor cell after one combined acquisition failure or a plurality of combined acquisition failures while in stationary mode.

20. The wireless device of claim 17, further comprising:
means for switching to mobility mode; and
means for removing a suspension of the combined acquisition of the neighbor cell.

21. The wireless device of claim 17, further comprising means for switching from stationary mode to mobility mode based on changes to a mode trigger flag.

22. The wireless device of claim 21, wherein the mode trigger flag is based on variation of at least one of:
a serving cell receive power,
a serving cell signal to noise ratio,
a receive power of one or more neighbor cells,
a signal to noise ratio of one or more neighbor cells, and
a change in a neighbor cell list.

23. The wireless device of claim 21, further comprising:
means for switching from mobility mode to stationary mode when the mode trigger flag indicates a stationary condition after a first time period; and
means for switching from stationary mode to mobility mode when the mode trigger flag indicates a mobility condition after a second time period.

24. The wireless device of claim 17, further comprising:
means for receiving a neighbor cell list on a broadcast channel;
means for initiating a frequency correction channel (FCCH) acquisition of a neighbor cell while in mobility mode;
means for switching from the mobility mode to the stationary mode after a failure of the FCCH acquisition of the neighbor cell based on changes to a mode trigger flag; and
means for initiating a combined acquisition of a neighbor cell while in stationary mode.

25. A non-transitory computer-readable medium for wireless communications, the computer-readable medium having instructions thereon, the instructions comprising:
code for causing a wireless communication device to perform subsequent combined acquisition of a neighbor cell based on a stationary mode and a mobility mode.

26. The non-transitory computer-readable medium of claim 25, wherein the combined acquisition of the neighbor cell comprises at least one of a frequency correction channel (FCCH) acquisition and a synchronization channel (SCH) decoding of the neighbor cell.

27. The non-transitory computer-readable medium of claim 25, further comprising code for causing the wireless communication device to suspend subsequent combined acquisition of the neighbor cell after one combined acquisition failure or a plurality of combined acquisition failures while in stationary mode.

28. The non-transitory computer-readable medium of claim 25, further comprising:
code for causing the wireless communication device to switch to mobility mode; and
code for causing the wireless communication device to remove a suspension of the combined acquisition of the neighbor cell.

29. The non-transitory computer-readable medium of claim 25, further comprising code for causing the wireless communication device to switch from stationary mode to mobility mode based on changes to a mode trigger flag.

30. The non-transitory computer-readable medium of claim 29, wherein the mode trigger flag is based on variation of at least one of:
a serving cell receive power,
a serving cell signal to noise ratio,
a receive power of one or more neighbor cells,
a signal to noise ratio of one or more neighbor cells, and
a change in a neighbor cell list.

31. The non-transitory computer-readable medium of claim 29, further comprising:
code for causing the wireless communication device to switch from mobility mode to stationary mode when the mode trigger flag indicates a stationary condition after a first time period; and
code for causing the wireless communication device to switch from stationary mode to mobility mode when the mode trigger flag indicates a mobility condition after a second time period.

32. The non-transitory computer-readable medium of claim 25, further comprising:
code for causing the wireless communication device to receive a neighbor cell list on a broadcast channel;
code for causing the wireless communication device to initiate a frequency correction channel (FCCH) acquisition of a neighbor cell while in mobility mode;
code for causing the wireless communication device to switch from the mobility mode to the stationary mode after a failure of the FCCH acquisition of the neighbor cell based on changes to a mode trigger flag; and
code for causing the wireless communication device to initiate a combined acquisition of a neighbor cell while in stationary mode.
